(19) United States
(12) Patent Application Publication
(10) Pub. No.: US 2014/0169319 A1
(43) Pub. Date: Jun. 19, 2014

(54) METHOD FOR TRANSMITTING UPLINK SIGNAL, USER EQUIPMENT, METHOD FOR RECEIVING UPLINK SIGNAL, AND BASE STATION

(71) Applicants: Suckchel Yang, Anyang-si (KR); Joonkui Ahn, Anyang-si (KR); Dongyoun Seo, Anyang-si (KR)

(72) Inventors: Suckchel Yang, Anyang-si (KR); Joonkui Ahn, Anyang-si (KR); Dongyoun Seo, Anyang-si (KR)

(73) Assignee: LG ELECTRONICS INC., Seoul (KR)

(21) Appl. No.: 14/235,335

(22) PCT Filed: Jul. 26, 2012
(86) PCT No.: PCT/KR2012/005978

§ 371 Date: Jan. 27, 2014

Related U.S. Application Data
(60) Provisional application No. 61/511,968, filed on Jul. 26, 2011.

(51) Int. Cl. H04W 72/04; H04L 5/00

(52) U.S. Cl. CPC H04W 72/0413; H04L 5/0055
USPC 370/329

(57) ABSTRACT

The present invention provides a method for a user equipment, which is included in a user equipment group that comprises a plurality of user equipments, transmitting to a base station an Acknowledgement/Negative ACK (ACK/NACK) signal with respect to downlink data that is received from the base station. The base station, according to the present invention, quasi-statically sets physical uplink control channel (PUCCH) resource identification information, which would be used by each of the plurality of user equipments, and dynamically allocates to the user equipment group a collection of PUCCH resources usable for transmitting ACK/NACK of the user equipment group. The user equipment, according to the present invention, transmits the ACK/NACK signal to the base station by using the PUCCH resource that is allocated to the user equipment from the collection of the PUCCH resources, which are dynamically allocated to the user equipment group, based on the PUCCH resource identification information that is quasi-statically allocated to the user equipment.

### TECHNICAL FIELD

The present invention relates to a wireless communication system. More particularly, the present invention relates to a method and apparatus for transmitting/receiving an uplink signal.

### BACKGROUND ART

With appearance and spread of machine-to-machine (M2M) communication and a variety of devices such as smartphones and tablet PCs and technology demanding a large amount of data transmission, data throughput needed in a cellular network has rapidly increased. To satisfy such rapidly increasing data throughput, carrier aggregation technology, cognitive radio technology, etc. for efficiently employing more frequency bands and multiple input multiple output (MIMO) technology, multi-base station (BS) cooperation technology, etc. for raising data capacity transmitted on limited frequency resources have been developed. In addition, a communication environment has evolved into increasing density of nodes accessible by a user at the periphery of the nodes. A node refers to a fixed point capable of transmitting/receiving a radio signal to/from a user equipment through one or more antennas. A communication system including high-density nodes may provide a better communication service to the user through cooperation between the nodes.

Due to introduction of new radio communication technology, the number of user equipments (UEs) to which a BS should provide a service in a prescribed resource region increases and the amount of uplink data and uplink control information that the BS should receive from the UEs increases. Since the amount of resources available to the BS for communication with UE(s) is finite, a new method for efficiently transmitting/receiving an uplink/downlink signal using the finite radio resources is needed.

### DETAILED DESCRIPTION OF THE INVENTION

### Technical Problems

The present invention provides a method and apparatus for transmitting/receiving an uplink signal or a downlink signal, for efficient communication between a base station and a UE group consisting of a plurality of UEs.

The technical objects that can be achieved through the present invention are not limited to what has been particularly described hereinabove and other technical objects not described herein will be more clearly understood by persons skilled in the art from the following detailed description.

### Technical Solutions

According to an aspect of the present invention, provided herein is a method for transmitting an uplink signal to a base station by a user equipment included in a user equipment group including a plurality of user equipments in a wireless communication system, the method including receiving a higher-layer signal including physical uplink control channel (PUCCH) resource ID information allocated to the user equipment from the base station; receiving acknowledgement (ACK)/negative ACK (NACK) resource information indicating a set of PUCCH resources available for ACK/NACK transmission of the user equipment group from the base station through a physical downlink control channel (PDCCH) or a physical downlink shared channel (PDSCH); and transmitting an ACK/NACK signal for downlink data received from the base station to the base station using a PUCCH resource corresponding to the PUCCH resource ID information allocated to the user equipment among the set of the PUCCH resources.

In another aspect of the present invention, provided herein is a user equipment included in a user equipment group including a plurality of user equipments, for transmitting an uplink signal to a base station in a wireless communication system, the user equipment including a radio frequency (RF) unit configured to transmit/receive a signal; and a processor configured to control the RF unit, wherein the processor controls the RF unit to receive a higher-layer signal including physical uplink control channel (PUCCH) resource ID information allocated to the user equipment from the base station, controls the RF unit to receive acknowledgement (ACK)/negative ACK (NACK) resource information indicating a set of PUCCH resources available for ACK/NACK transmission of the user equipment group from the base station through a physical downlink control channel (PDCCH) or a physical downlink shared channel (PDSCH), and controls the RF unit to transmit an ACK/NACK signal for downlink data received from the base station to the base station using a PUCCH resource corresponding to the PUCCH resource ID information allocated to the user equipment among the set of the PUCCH resources

In another aspect of the present invention, provided herein is a method for receiving, by a base station, an uplink signal from a user equipment included in a user equipment group including a plurality of user equipments in a wireless communication system, the method including transmitting a higher-layer signal including physical uplink control channel (PUCCH) resource ID information allocated to the user equipment to the user equipment; transmitting acknowledgement (ACK)/negative ACK (NACK) resource information indicating a set of PUCCH resources available for ACK/NACK transmission of the user equipment group to the user equipment through a physical downlink control channel (PDCCH) or a physical downlink shared channel (PDSCH); and receiving an ACK/NACK signal for downlink data transmitted to the user equipment from the user equipment using a PUCCH resource corresponding to the PUCCH resource ID information allocated to the user equipment among the set of the PUCCH resources.

In another aspect of the present invention, provided herein is a base station for receiving an uplink signal from a user equipment included in a user equipment group including a plurality of user equipments in a wireless communication system, the base station including a radio frequency (RF) unit configured to transmit/receive a signal; and a processor configured to control the RF unit, wherein the processor controls the RF unit to transmit a higher-layer signal including physical uplink control channel (PUCCH) resource ID information allocated to the user equipment to the user equipment, controls the RF unit to transmit acknowledgement (ACK)/negative ACK (NACK) resource information indicating a set of PUCCH resources available for ACK/NACK transmission of the user equipment group to the user equipment through a physical downlink control channel (PDCCH) or a physical downlink shared channel (PDSCH), and controls the RF unit to receive an ACK/NACK signal for downlink data transmitted to the user equipment from the user equipment using a PUCCH resource corresponding to the PUCCH resource ID information allocated to the user equipment among the set of the PUCCH resources.

In each aspect of the present invention, the PUCCH resource ID information allocated to the user equipment may be information for identifying one PUCCH resource in the set of the PUCCH resources.

In each aspect of the present invention, the ACK/NACK resource information may be information indicating a first PUCCH resource in the set of the PUCCH resources or information indicating one or more resource blocks occupied by the set of the PUCCH resources.

In each aspect of the present invention, the PDCCH through which the ACK/NACK resource information is received may be different from a PDCCH through which downlink control information for the downlink data is transmitted.

The above technical solutions are merely some parts of the embodiments of the present invention and various embodiments into which the technical features of the present invention are incorporated can be derived and understood by persons skilled in the art from the following detailed description of the present invention.

### Advantageous Effects

According to the present invention, an uplink/downlink signal for a plurality of UEs can be efficiently transmitted/received.

Effects according to the present invention are not limited to what has been particularly described hereinabove and other advantages not described herein will be more clearly understood by persons skilled in the art from the following detailed description of the present invention.

### DESCRIPTION OF DRAWINGS

The accompanying drawings, which are included to provide a further understanding of the invention, illustrate embodiments of the invention and together with the description serve to explain the principle of the invention.

FIG. 1 illustrates the structure of a radio frame used in a wireless communication system.

FIG. 2 illustrates the structure of a downlink (DL)/uplink (UL) slot in a wireless communication system.

FIG. 3 illustrates the structure of a DL subframe used in a 3rd generation partnership project (3GPP) long term evolution (LTE)/LTE-advanced (LTE-A) system.

FIG. 4 illustrates the structure of a UL subframe used in a 3GPP LTE/LTE-A system.

FIG. 5 illustrates logical arrangement of PUCCH resources used in one cell.

FIG. 6 illustrates an example for determining PUCCH resources for acknowledgement (ACK)/negative ACK (NACK) in a 3GPP LTE(-A) system.

FIG. 7 illustrates UL ACK/NACK transmission according to the present invention.

FIG. 8 is a block diagram illustrating elements of a transmitting device 10 and a receiving device 20 for implementing the present invention.

### BEST MODE FOR CARRYING OUT THE INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

In the present invention, a user equipment (UE) may be a fixed or mobile device. Examples of the UE include various devices that transmit and receive user data and/or various kinds of control information to and from a base station. The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a base station (BS) generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc.

In the present invention, a node refers to a fixed point capable of transmitting/receiving a radio signal through communication with a UE. Various types of BSs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, a node may not be a BS. As an example, a radio remote head (RRH) or a radio remote unit (RRU) may be a node. At least one antenna is installed per node. The antenna may mean a physical antenna, an antenna port, a virtual antenna, or an antenna group. A node may be referred to as a point. Unlink an existing centralized antenna system (CAS) (i.e. a single-node system) controlled by one BS controller by centralizing antennas in a BS, a multi-node system includes a plurality of nodes separated from one another by a predetermined distance. The plurality of nodes may be managed by one or more BSs or BS controllers for controlling operation of each node or scheduling data to be transmitted/received through each node. Each node may be connected to a BS or BS controller for managing the corresponding node through a cable or a dedicated line. In the multi-node system, the same cell identifier (ID) or different cell IDs may be used to transmit/receive signals to/from a plurality of nodes. If the plurality of nodes have the same cell ID, each of the plurality of nodes operates as a partial antenna group of one cell. In the multi-node system, if the nodes have different cell IDs, the multi-node system may be regarded as a multi-cell (e.g. macro-cell/femto-cell/pico-cell) system. If multiple cells formed respectively by the multiple nodes are configured in an overlaid form, a network formed by the multiple cells is especially referred to as a multi-tier network.

Meanwhile, in the present invention, a cell refers to a prescribed geographic area to which one or more nodes provide a communication service. Accordingly, in the present invention, communication with a specific cell may mean communication with a BS or a node which provides a communication service to the specific cell. In addition, a downlink/uplink signal of a specific cell refers to a downlink/uplink signal from/to a BS or a node which provides a communication service to the specific cell. A channel state/quality of a specific cell refers to a channel state/quality of a channel or communication link formed between a BS or a node which provides a communication service to the specific cell and a UE.

In the present invention, a physical downlink control channel (PDCCH), a physical control format indicator channel (PCFICH), a physical hybrid automatic retransmit request indicator channel (PHICH), and a physical downlink shared channel (PDSCH) refer to a set of time-frequency resources or resource elements (REs) carrying downlink control information (DCI), a set of time-frequency resources or REs carrying a control format indicator (CFI), a set of time-frequency resources or REs carrying downlink acknowledgement (ACK)/negative ACK (NACK), and a set of time-frequency resources or REs carrying downlink data, respectively. In addition, a physical uplink control channel (PUCCH), a physical uplink shared channel (PUSCH), and a physical random access channel (PRACH) refer to a set of time-frequency resources or REs carrying uplink control information (UCI), a set of time-frequency resources or REs carrying uplink data, and a set of time-frequency resources or REs carrying a random access signal, respectively. In the present invention, in particular, a time-frequency resource or RE that is assigned to or belongs to PDCCH/PCFICH/PHICH/PDSCH/PUCCH/PUSCH/PRACH is referred to as a PDCCH/PCFICH/PHICH/PDSCH/PUCCH/PUSCH/PRACH RE or PDCCH/PCFICH/PHICH/PDSCH/PUCCH/PUSCH/PRACH resource, respectively. Therefore, in the present invention, PUCCH/PUSCH/PRACH transmission of a UE is conceptually identical to UCI/uplink data/random access signal transmission on PUSCH/PUCCH/PRACH, respectively. In addition, PDCCH/PCFICH/PHICH/PDSCH transmission of a BS is conceptually identical to downlink data/DCI transmission on PDCCH/PCFICH/PHICH/PDSCH, respectively.

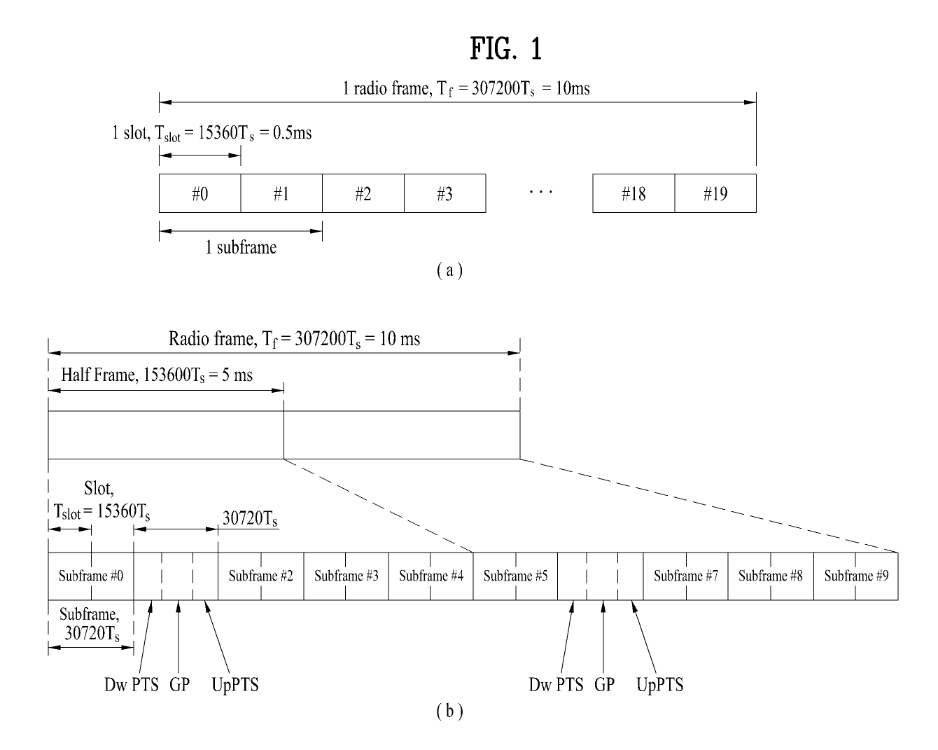

FIG. 1 illustrates the structure of a radio frame used in a wireless communication system. Specifically, FIG. 1(a) illustrates a frame structure for frequency division duplex (FDD) used in a 3GPP LTE/LTE-A system and FIG. 1(b) illustrates a frame structure for time division duplex (TDD) used in a 3GPP LTE/LTE-A system.

Referring to FIG. 1, a radio frame used in a 3GPP LTE/LTE-A system is 10 ms (307,200·Tₛ) in duration. The radio frame is divided into 10 subframes of equal size. Subframe numbers may be assigned to the 10 subframes within one radio frame, respectively. Here, Tₛ denotes sampling time where Tₛ=1/(2048*15 kHz). Each subframe is 1 ms long and is further divided into two slots. 20 slots may be sequentially numbered from 0 to 19 in one radio frame. Duration of each slot is 0.5 ms. A time interval in which one subframe is transmitted is defined as a transmission time interval (TTI). Time resources may be distinguished by a radio frame number (or radio frame index), a subframe number (or subframe index), a slot number (or slot index), and the like.

A radio frame may have different configurations according to duplex mode. In FDD mode for example, since downlink (DL) transmission and uplink (UL) transmission are discriminated according to frequency, a radio frame for a specific frequency band includes either DL subframes or UL subframes. In TDD mode, since DL transmission and UL transmission are discriminated according to time, a radio frame for a specific frequency band includes both DL subframes and UL subframes.

Table 1 shows an exemplary UL-DL configurations for subframes in a radio frame in TDD mode.

TABLE 1

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a DL subframe, U denotes a UL subframe, and S denotes a special subframe. The special subframe includes three fields, i.e. a downlink pilot time slot (DwPTS), a guard period (GP), and an uplink pilot time slot (UpPTS). DwPTS is a time slot reserved for DL transmission and UpPTS is a time slot reserved for UL transmission. Table 2 shows an exemplary special subframe configuration.

TABLE 2

| | Normal cyclic prefix | | | Extended cyclic prefix | | |
|---|---|---|---|---|---|---|
| | in downlink | | | in downlink | | |
| | | UpPTS | | | UpPTS | |
| | | Normal | Extended | | Normal | Extended |
| Special | | cyclic | cyclic | | cyclic | cyclic |
| subframe | | prefix in | prefix in | | prefix in | prefix in |
| configuration | DwPTS | uplink | uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

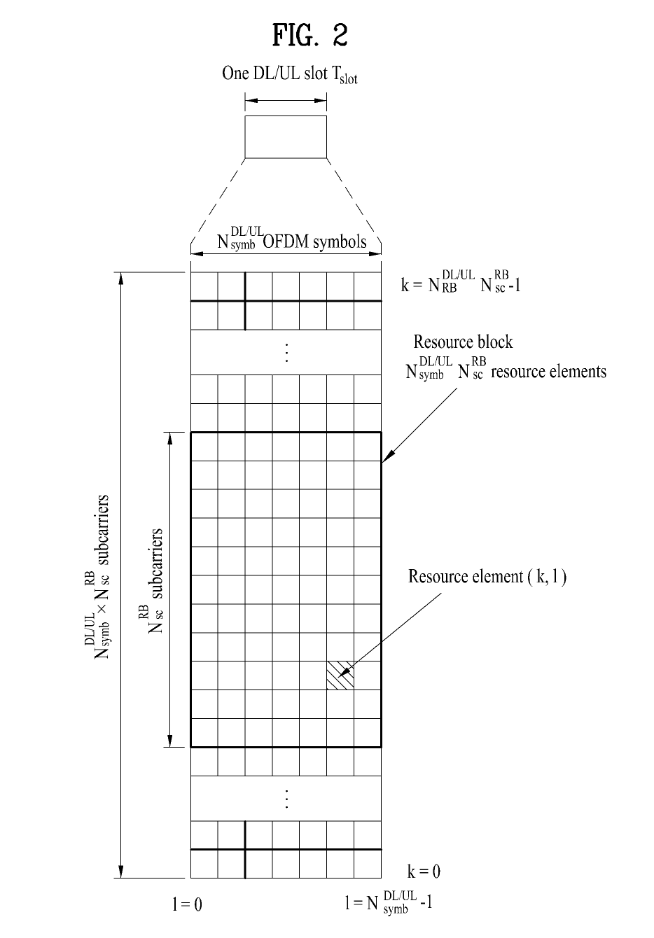

FIG. 2 illustrates the structure of a DL/UL slot in a wireless communication system. In particular, FIG. 2 illustrates the structure of a resource grid of a 3GPP LTE/LTE-A system. One resource grid is defined per antenna port.

Referring to FIG. 2, a slot includes a plurality of orthogonal frequency division multiplexing (OFDM) symbols in the time domain and a plurality of resource blocks (RBs) in the frequency domain. The OFDM symbol may refer to one symbol duration. Referring to FIG. 2, a signal transmitted in each slot may be expressed by a resource grid including N^{DL/UL}_{RB}*N^{RB}_{sc} subcarriers and N^{DL/UL}_{symb} OFDM symbols. N^{DL}_{RB} denotes the number of RBs in a DL slot and N^{UL}_{RB} denotes the number of RBs in a UL slot. N^{DL}_{RB} and N^{UL}_{RB} depend upon DL transmission bandwidth and UL transmission bandwidth, respectively. N^{DL}_{symb} denotes the number of OFDM symbols in a DL slot, N^{UL}_{symb} denotes the number of OFDM symbols in a UL slot, and N^{RB}_{sc} denotes the number of subcarriers configuring one RB.

An OFDM symbol may be referred to as an OFDM symbol, an SC-FDM symbol, etc. according to a multiple access scheme. The number of OFDM symbols included in one slot may vary according to channel bandwidth and CP length. For example, in a normal cyclic prefix (CP) case, one slot includes 7 OFDM symbols. In an extended CP case, one slot includes 6 OFDM symbols. Although one slot of a subframe including 7 OFDM symbols is shown in FIG. 2 for convenience of description, embodiments of the present invention are similarly applicable to subframes having a different number of OFDM symbols. Referring to FIG. 2, each OFDM symbol includes N^{DL/UL}_{RB}*N^{RB}_{sc} subcarriers in the frequency domain. The subcarrier may be categorized as a data subcarrier for data transmission, a reference signal subcarrier for reference signal transmission, and a null subcarrier for a guard band and a direct current (DC) component. The null subcarrier for the DC component is unused and is mapped to a carrier frequency fₒ in a process of generating an OFDM signal or in a frequency up-conversion process. The carrier frequency is also called center frequency.

One RB is defined as N^{DL/UL}_{symb} (e.g. 7) consecutive OFDM symbols in the time domain and as N^{RB}_{sc} (e.g. 12) consecutive subcarriers in the frequency domain. For reference, a resource composed of one OFDM symbol and one subcarrier is referred to as a resource element (RE) or tone. Accordingly, one RB includes N^{DL/UL}_{symb}*N^{RB}_{sc} REs. Each RE within a resource grid may be uniquely defined by an index pair (k, l) within one slot. k is an index ranging from 0 to N^{DL/UL}_{RB}*N^{RB}_{sc}−1 in the frequency domain, and 1 is an index ranging from 0 to N^{DL/UL}_{symb}−1 in the time domain.

In one subframe, two RBs respectively located in two slots of the subframe while occupying the same N^{RB}_{sc} consecutive subcarriers are referred to as a physical resource block (PRB) pair. Two RBs configuring a PRB pair have the same PRB number (or the same PRB index).

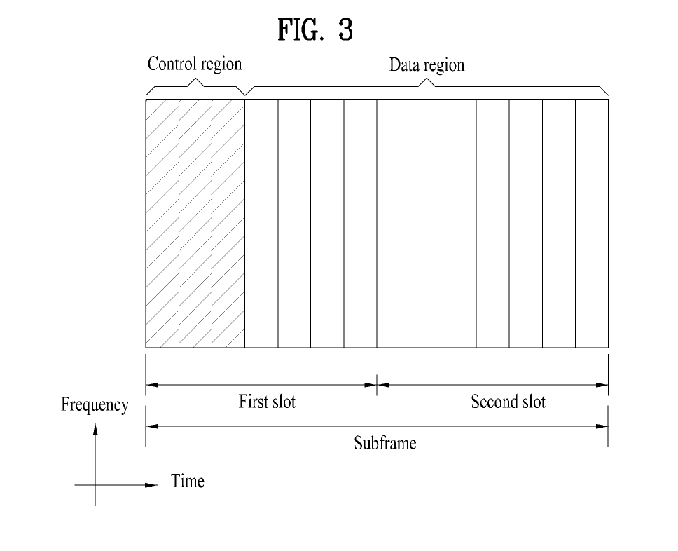

FIG. 3 illustrates the structure of a DL subframe used in a 3GPP LTE/LTE-A system.

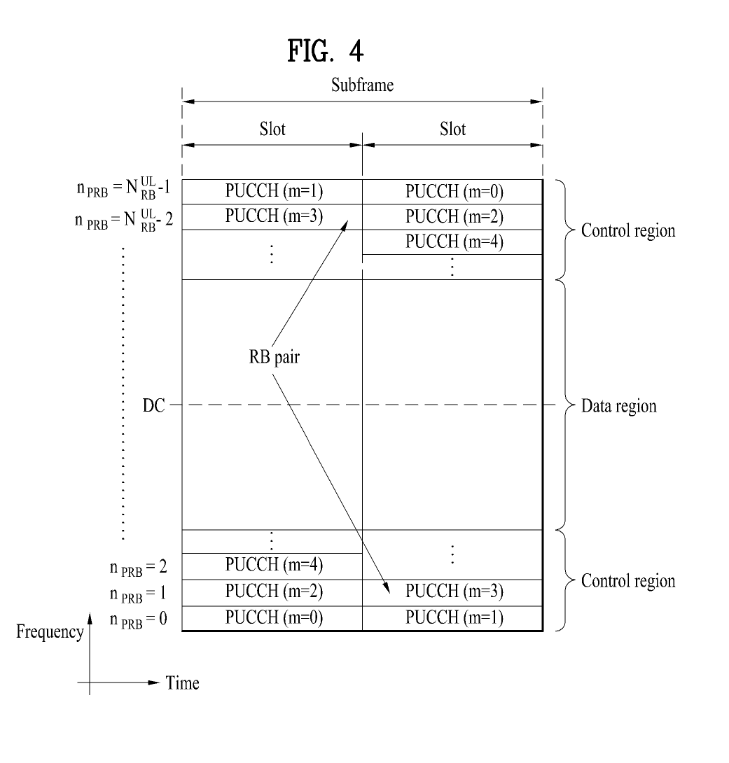

Referring to FIG. 3, a DL subframe is divided into a control region and a data region in the time domain. Referring to FIG. 4, a maximum of 3 (or 4) OFDM symbols located in a front part of a first slot of a subframe correspond to the control region. Hereinafter, a resource region usable for PDCCH transmission in the DL subframe is referred to as a PDCCH region. OFDM symbols other than the OFDM symbol(s) used in the control region correspond to the data region to which a PDSCH is allocated. Hereinafter, a resource region usable for PDSCH transmission in the DL subframe is referred to as a PDSCH region. Examples of a DL control channel used in 3GPP LTE include a PCFICH, a PDCCH, a PHICH, etc. The PCFICH is transmitted in the first OFDM symbol of a subframe and carries information about the number of OFDM symbols used for transmission of a control channel within a subframe. The PHICH carries a hybrid automatic repeat request (HARQ) ACK/NACK signal as a response to UL transmission.

Control transmitted via a PDCCH is referred to as downlink control information (DCI). The DCI includes resource allocation information for a UE or a UE group and other control information. For example, the DCI includes transmission format and resource allocation information of a downlink shared channel (DL-SCH), transmission format and resource allocation information of an uplink shared channel (UL-SCH), paging information on a paging channel (PCH), system information on a DL-SCH, resource allocation information of a higher-layer control message such as a random access response transmitted on a PDSCH, a transmit power control command set of individual UEs in a UE group, a Tx power control command, activation indication information of voice over IP (VoIP), a downlink assignment index (DAI), etc. The transmit format and resource allocation information of the DL-SCH is referred to as DL scheduling information or DL grant and the transmit format and resource allocation information of the UL-SCH is referred to as UL scheduling information or UL grant.

A PDCCH is transmitted on one control channel element (CCE) or an aggregate of a plurality of consecutive CCEs. The CCE is a logical allocation unit used to provide a coding rate to a PDCCH based on a radio channel state. The CCE corresponds to a plurality of resource element groups (REGs). For example, one CCE corresponds to 9 REGs and one REG corresponds to 4 REs. In a 3GPP LTE system, a CCE set in which a PDCCH can be located for each UE is defined. A CCE set in which the UE can detect a PDCCH thereof is referred to as a PDCCH search space or simply as a search space (SS). An individual resource on which the PDCCH can be transmitted in the SS is referred to as a PDCCH candidate. A set of PDCCH candidates that are to be monitored by the UE is defined as the SS. In the 3GPP LTE/LTE-A system, SSs for respective DCI formats may have different sizes and a dedicated SS and a common SS are defined. The dedicated SS is a UE-specific SS and is configured for each individual UE. The common SS is configured for a plurality of UEs. One PDCCH candidate corresponds to 1, 2, 4, or 8 CCEs according to a CCE aggregation level. A BS transmits an actual PDCCH (DCI) on an arbitrary PDCCH candidate in an SS and a UE monitors the SS to detect the PDCCH (DCI). Here, monitoring refers to attempting to decode each PDCCH in a corresponding SS according to all monitored DCI formats. The UE may detect a PDCCH thereof by monitoring a plurality of PDCCHs. Basically, the UE does not know the location at which a PDCCH thereof is transmitted. Therefore, the UE attempts to decode all PDCCHs of a corresponding DCI format in every subframe until a PDCCH having an identifier thereof is received and this process is referred to as blind detection (or blind decoding) (BD).

The BS may transmit data for a UE or UE group in the data region. Data transmitted in the data region is referred to as user data. A PDSCH may be allocated to the data region for user data transmission. A PCH and a DL-SCH are transmitted on the PDSCH. The UE may decode control information received on a PDCCH and thus read data received on the PDSCH. DCI transmitted on one PDCCH may differ in size and usage according to DCI format and differ in size according to coding rate. Information indicating to which UE or UE group PDSCH data is transmitted and information indicating how the UE or UE group should receive and decode the PDSCH data are transmitted on the PDCCH. For example, it is assumed that a specific PDCCH is cyclic redundancy check (CRC)-masked with a radio network temporary identity (RNTI) ‘A’ and information about data transmitted using a radio resource ‘B’ (e.g. frequency location) and using transport format information ‘C’ (e.g. transmission block size, modulation scheme, coding information, etc.) is transmitted in a specific DL subframe. Then, the UE monitors PDCCHs using RNTI information thereof. The UE having the RNTI ‘A’ receives a PDCCH and receives a PDSCH indicated by ‘B’ and ‘C’ through information of the received PDCCH.

FIG. 4 illustrates the structure of a UL subframe used in a 3GPP LTE/LTE-A system.

Referring to FIG. 4, a UL subframe may be divided into a control region and a data region in the frequency domain. One or several PUCCHs may be allocated to the control region to deliver UCI. One or several PUSCHs may be allocated to the data region of the UE subframe to deliver user data. The control region and the data region in the UL subframe may also be referred to as a PDCCH region and a PUSCH region, respectively. A sounding reference signal (SRS) may be allocated to the data region. The SRS is transmitted on the last OFDM symbol of the UL subframe in the time domain and is transmitted in a data transmission band, that is, a data region, of the UL subframe in the frequency domain. SRSs of several UEs, which are transmitted/received on the last OFDM symbol of the same subframe, can be distinguished according to a frequency location/sequence.

If a UE employs an SC-FDMA scheme in UL transmission, in a 3GPP LTE release-8 or release-9 system, a PUCCH and a PUSCH cannot be simultaneously transmitted on one carrier in order to maintain a single carrier property. In a 3GPP LTE release-10 system, support/non-support of simultaneous transmission of the PUCCH and the PUSCH may be indicated by higher layers.

In the UL subframe, subcarriers distant from a direct current (DC) subcarrier are used as the control region. In other words, subcarriers located at both ends of a UL transmission bandwidth are allocated to transmit UCI. A DC subcarrier is a component unused for signal transmission and is mapped to a carrier frequency f₀ in a frequency up-conversion process. A PUCCH for one UE is allocated to an RB pair belonging to resources operating on one carrier frequency and RBs belonging to the RB pair occupy different subcarriers in two slots. The PUCCH allocated in this way is expressed by frequency hopping of the RB pair allocated to the PUCCH over a slot boundary. If frequency hopping is not applied, the RB pair occupies the same subcarrier.

The PUCCH may be used to transmit the following control information.
Scheduling request (SR): SR is information used to request a UL-SCH resource and is transmitted using an on-off keying (OOK) scheme.
HARQ-ACK: HARQ-ACK is a response to a PDCCH and/or a response to a DL data packet (e.g. a codeword) on a PDSCH. HARQ-ACK indicates whether the PDCCH or PDSCH has been successfully received. 1-bit HARQ-ACK is transmitted in response to a single DL codeword and 2-bit HARQ-ACK is transmitted in response to two DL codewords. A HARQ-ACK response includes a positive ACK (simply, ACK), negative ACK (NACK), discontinuous transmission (DTX), or NACK/DRX. HARQ-ACK is used interchangeably with HARQ ACK/NACK and ACK/NACK.
Channel state information (CSI): CSI is feedback information for a DL channel. MIMO-related feedback information includes a rank indicator (RI) and a precoding matrix indicator (PMI).

The amount of UCI that can be transmitted by a UE in a subframe depends on the number of SC-FDMA symbols available for control information transmission. SC-FDMA symbols available for UCI correspond to SC-FDMA symbols other than SC-FDMA symbols used for reference signal transmission in a subframe. In the case of a subframe in which an SRS is configured, the last SC-FDMA symbol in the subframe is excluded from the SC-FDMA symbols available for UCI. A reference signal is used for coherent PUCCH detection. A PUCCH supports various formats according to transmitted information.

Table 3 shows a mapping relationship between PUCCH formats and UCI in an LTE/LTE-A system.

TABLE 3

| | | Number of | | |
|---|---|---|---|---|
| PUCCH | Modulation | bits per | | |
| format | scheme | subframe | Usage | Etc. |
| 1 | N/A | N/A (exist or | SR (Scheduling | |
| | | absent) | Request) | |
| 1a | BPSK | 1 | ACK/NACK or | One codeword |
| | | | SR + ACK/ | |
| | | | NACK | |
| 1b | QPSK | 2 | ACK/NACK or | Two |
| | | | SR + ACK/ | codeword |
| | | | NACK | |
| 2 | QPSK | 20 | CQI/PMI/RI | Joint coding |
| | | | | ACK/NACK |
| | | | | (extended CP) |
| 2a | QPSK + BPSK | 21 | CQI/PMI/RI + | Normal CP |
| | | | ACK/NACK | only |
| 2b | QPSK + QPSK | 22 | CQI/PMI/RI + | Normal CP |
| | | | ACK/NACK | only |
| 3 | QPSK | 48 | ACK/NACK or | |
| | | | SR + ACK/ | |
| | | | NACK or | |
| | | | CQI/PMI/RI + | |
| | | | ACK/NACK | |

Referring to Table 3, PUCCH format 1 series and PUCCH format 3 series are mainly used to transmit ACK/NACK information and PUCCH format 2 series is mainly used to carry channel state information (CSI) such as channel quality indicator (CQI)/precoding matrix indicator (PMI)/rank indicator (RI).

A UE is assigned PUCCH resources for UCI transmission by a BS through higher-layer signaling, dynamic control signaling, or an implicit scheme. Physical resources used for PUCCHs depend on two parameters, N⁽²⁾_{RB} and N⁽¹⁾_{CS}, given by higher layers. The parameter N⁽²⁾_{RB}, which is equal to or greater than 0 (N⁽²⁾_{RB}≧0), indicates available bandwidth for PUCCH format 2/2a/2b transmission at each slot and is expressed as an integer multiple of N^{RB}_{sc}. The parameter N⁽¹⁾_{CS} indicates the number of cyclic shifts used for PUCCH format 1/1a/1b in an RB used for a mixture of format 1/1a/1b and format 2/2a/2b. A value of N⁽¹⁾_{CS} is an integer multiple of Δ^{PUCCH}_{shift} within a range of {0, 1, . . . , 7}. Δ^{PUCCH}_{shift} is provided by higher layers. If N⁽¹⁾_{CS} is 0, no mixed RBs are present. At each slot, at most one RB supports a mixture of PUCCH format 1/1a/1b and PUCCH format 2/2a/2b. Resources used for transmission of PUCCH format 1/1a/1b, PUCCH format 2/2a/2b, and PUCCH format 3 by antenna port p are expressed by n^{(1,p)}_{PUCCH}, n^{(2,p)}_{PUCCH}<N⁽²⁾_{RB}N^{RB}_{sc}+ceil(N⁽¹⁾_{cs}/8)·(N^{RB}_{sc}−N⁽¹⁾_{cs}−2), and n^{(3,p)}_{PUCCH}, respectively, which are indexes of non-negative integer indexes.

More specifically, according to a specific rule predefined for each PUCCH format, an orthogonal sequence (orthogonal cover sequence (OC) or orthogonal cover code (OCC)) and/or a cyclic shift (CS) to be applied to UCI from PUCCH resource indexes is determined and indexes of two RBs in a subframe, to which PUCCHs are to be mapped, are provided. For example, a PRB for PUCCH transmission in slot nₛ is given as follows.

$${n}_{PRB} = \{ \begin{matrix}⌊ \frac{m}{2} ⌋ & if ( m + {n}_{s} mod 2 ) mod 2 = 0 \\ {N}_{RB}^{UL} - 1 - ⌊ \frac{m}{2} ⌋ & if ( m + {n}_{s} mod 2 ) mod 2 = 1\end{matrix} \qquad Equation 1$$

In Equation 1, m depends on a PUCCH format and is given as Equation 2, Equation 3, and Equation 4 for PUCCH format 1/1a/1b, PUCCH format 2/2a/2b, and PUCCH format 3, respectively.

$$m = \{ \begin{matrix}{N}_{RB}^{( 2 )} & if {n}_{PUCCH}^{( 1 , \tilde{p} )} < c \cdot {N}_{cs}^{( 1 )} / {Δ}_{shift}^{PUCCH} \\ ⌊ \frac{{n}_{PUCCH}^{( 1 , \tilde{p} )} - c \cdot {N}_{cs}^{( 1 )} / {Δ}_{shift}^{PUCCH}}{c \cdot {N}_{sc}^{RB} / {Δ}_{shift}^{PUCCH}} ⌋ + {N}_{RB}^{( 2 )} + ⌈ \frac{{N}_{cs}^{( 1 )}}{8} ⌉ & otherwise\end{matrix} \\ c = \{ \begin{matrix}3 & normal cyclic prefix \\ 2 & extended cyclic prefix\end{matrix} \qquad Equation 2$$

In Equation 2, n^{(1,p)}_{PUCCH} denotes a PUCCH resource index of antenna port p for PUCCH format 1/1a/1b. In the case of an ACK/NACK PUCCH, n^{(1,p)}_{PUCCH} is a value implicitly determined by the first CCE index of a PDCCH carrying scheduling information of a corresponding PDSCH.

$$m = ⌊ {n}_{PUCCH}^{( 2 , \tilde{p} )} / {N}_{sc}^{RB} ⌋ \qquad Equation 3$$

where n⁽²⁾_{PUCCH} denotes a PUCCH resource index of antenna port p for PUCCH format 2/2a/2b and is a value transmitted to a UE from a BS through higher-layer signaling.

m=└n_{PUCCH}^{(3,\tilde{p})/N}_{SF,0}^{PUCCH}┘ Equation 4

n⁽³⁾_{PUCCH} denotes a PUCCH resource index of antenna port p for PUCCH format 3 and is a value transmitted to a UE from a BS through higher-layer signaling. N^{PUCCH}_{SF,0} indicates a spreading factor for the first slot of a subframe. For both slots of a subframe using normal PUCCH format 3, N^{PUCCH}_{SF,0} is 5. For first and second slots of a subframe using reduced PUCCH format 3, N^{PUCCH}_{SF,0} is 5 and 4, respectively. Hereinafter, a PUCCH resource determined by linkage to a CCE index of a PDCCH will be referred to as an implicit PUCCH resource and a PUCCH resource determined by explicitly transmitting a PUCCH resource index by a BS to a UE will be referred to as an explicit PUCCH resource.

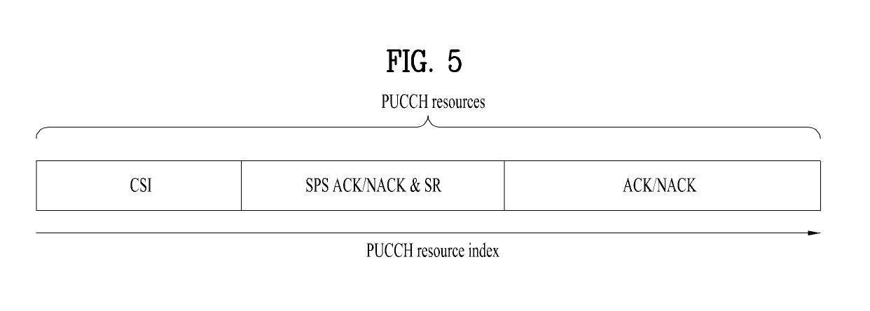

FIG. 5 illustrates logical arrangement of PUCCH resources used in one cell.

PUCCH resources are configured based on a cell ID. The PUCCH resources configured based on one cell ID includes PUCCH resources for CSI, PUCCH resources semi-persistent scheduling (SPS) ACK/NACK and SR, and PUCCH resources for dynamic ACK/NACK (i.e. PUCCH resources dynamically allocated by linkage with a PDCCH). Hereinafter, a PUCCH resource for CSI will be referred to as a CSI PUCCH resource or a CSI resource, a PUCCH resource for SPS ACK/NACK will be referred to as an SPS ACK/NACK PUCCH resource or an SPS ACK/NACK resource, a PUCCH resource for SR will be referred to an SR PUCCH resource or an SR resource, and a PUCCH resource for ACK/NACK associated with a PDCCH will be referred to as an ACK/NACK PUCCH resource or an ACK/NACK resource.

Referring to FIG. 5, PUCCH resources based on one cell ID are arranged in order of CSI PUCCH resources, SPS ACK/NACK and SR PUCCH resources, and ACK/NACK PUCCH resources in the direction of a direct current (DC) subcarrier from subcarriers distant from the DC subcarrier. In other words, PUCCH resources semi-statically configured by higher-layer signaling are located at an outer side of UL transmission bandwidth and dynamically configured ACK/NACK PUCCH resources are located nearer a center frequency than the semi-statically configured PUCCH resources.

Referring back to Equation 2, PUCCH resources for dynamic ACK/NACK are not pre-allocated to each UE and a plurality of UEs in a cell dividedly uses a plurality of PUCCH resources at each timing. For example, PUCCH resources used by the UE to carry ACK/NACK are dynamically determined based on a PDCCH carrying scheduling information for a PDSCH carrying corresponding DL data. An entire region in which PDCCHs are transmitted in each DL subframe includes a plurality of CCEs and a PDCCH transmitted to the UE is composed of one or more CCEs. The UE transmits ACK/NACK for the PDCCH or ACK/NACK for a PDSCH scheduled by the PDCCH, through a PUCCH resource linked to a specific CCE (e.g. first CCE) among CCEs constituting the PDCCH received thereby.

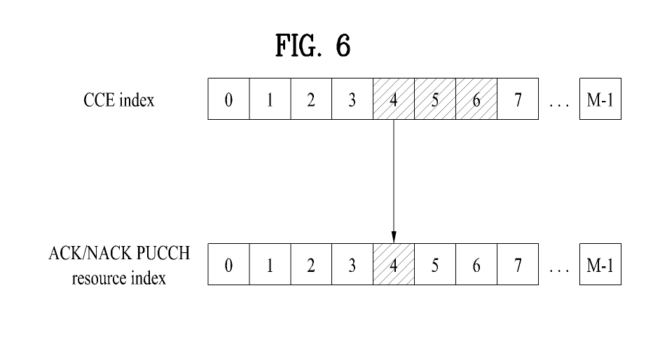

FIG. 6 illustrates an example for determining PUCCH resources for ACK/NACK in a 3GPP LTE(-A) system. Particularly, FIG. 6 illustrates the case in which a maximum of M CCEs is present in a DL subframe and a maximum of M ACK/NACK PUCCH resources is reserved in a UL subframe.

Referring to FIG. 6, each ACK/NACK PUCCH resource index corresponds to each PUCCH resource for ACK/NACK. As illustrated in FIG. 6, assuming that scheduling information for a PDSCH is transmitted to a UE through a PDCCH including CCE indexes 4 to 6 and CCE index 4 is linked to PUCCH resource index 4, the UE transmits ACK/NACK to a BS on ACK/NACK PUCCH resource index 4 corresponding to CCE index 4 constituting the PDCCH. Specifically, in the 3GPP LTE/LTE-A system, a PUCCH resource index for transmission by two antenna ports p₀ and p₁ is determined as follows.

n_{PUCCH}^{(1,p=p}^{₀}⁾=n_{CCE}+N_{PUCCH}⁽¹⁾ Equation 5

n_{PUCCH}^{(1,p=p}^{₁}⁾=n_{CCE}+1+N_{PUCCH}⁽¹⁾ Equation 6

Here, n^{(1,p=p}^{₀}⁾_{PUCCH} denotes a PUCCH resource index (i.e. number) to be used by antenna port p₀, n^{(1,p=p}^{₁}⁾_{PUCCH} denotes a PUCCH resource index to be used by antenna port p₁, and N⁽¹⁾_{PUCCH} denotes a signaling value received from higher layers. n_{CCE} is the lowest of CCE indexes used for PDCCH transmission. For example, if a CCE aggregation level is 2 or more, the first CCE index among a plurality of CCE indexes aggregated for PDCCH transmission is used to determine an ACK/NACK PUCCH resource.

In each UE, an ACK/NACK signal is transmitted on different resources including different CSs (frequency domain codes) of a computer-generated constant amplitude zero autocorrelation (CG-CAZAC) sequence and OCs (time domain spread codes). An OC includes, for example, a Walsh/discrete Fourier transform (DFT) OC. An orthogonal sequence (e.g. [w₀, w₁, w₂, w₃]) may be applied in either an arbitrary time domain (after fast Fourier transform (FFT) modulation) or an arbitrary frequency domain (before FFT modulation). If the number of CSs is 6 and the number of OCs is 3, a total of 18 UEs may be multiplexed in the same physical resource block (PRB) based on a single antenna port. In other words, PUCCH resources used for transmission of an ACK/NACK signal may be distinguished by an OCC, a CS (or a CAZAC CS (CCS)), and a PRB. If any one of the OCC, CS, and PRB of PUCCH resources differs, the PUCCH resources may be different resources.

According to a 3GPP LTE/LTE-A system up to now, all UEs serviced in a specific cell semi-statically receive information indicating the same N⁽¹⁾_{PUCCH} from a BS of the cell. That is, according the existing 3GPP LTE/LTE-A system, UEs located in a specific cell share PUCCH resources after N⁽¹⁾_{PUCCH} and the PUCCH resources are respectively linked to CCE indexes commonly applied to the specific cell.

Recently, machine type communication (MTC) has emerged as one important communication standardization issue. MTC refers to information exchange performed between a machine and a BS without involving persons or with minimal human intervention. For example, MTC may be used for data communication of measurement/sensing/reporting such as meter reading, water level measurement, use of a surveillance camera, inventory reporting of a vending machine, etc. and may be used for automatic applications or firmware update processes for a plurality of UEs. In MTC, since there is less transmission data and there are many UEs operating per cell, burden of the BS significantly increases if signal transmission for UL/DL scheduling/feedback for each UE is performed at each timing. Accordingly, the present invention aims to reduce overhead of a control channel by grouping a plurality of UEs for common UL or DL transmission and performing UL/DL scheduling per UE group. For example, in a PDSCH region scheduled by a PDCCH carrying DL grant (hereinafter, a DL grant PDCCH), DL data signals for a plurality of UEs belonging to one UE group may be multiplexed and simultaneously transmitted. A PUSCH region scheduled by a PDCCH carrying UL grant (hereinafter, a UL grant PDCCH) may include PUSCH transmission resources allocated to a plurality of UEs belonging to one UE group. In the following description, a DL/UL grant PDCCH refers to a PDCCH transmitted for scheduling or feedback on a UE group basis.

In the case of UL scheduling on a UE group basis, it may be desirable that a plurality of UEs in a UE group in a PUSCH region scheduled by one UL grant PDCCH be multiplexed in the form of transmitting UL data thereof through individual PUSCHs using different UL RB indexes and/or demodulation reference signal (DMRS) CSs. In this case, a PHICH resource for transmitting an ACK/NACK signal for a corresponding PUSCH may be differently distinguished/allocated with respect to each of the UEs in the UE group without entailing additional signaling. In other words, the BS may allocate different PHICH resources to the UEs in the UE group by reusing only a conventional PHICH allocation scheme. However, in the case of DL scheduling, scheduling information of DL data for the plurality of UEs in the UE group is transmitted only through one DL grant PDCCH and a PUCCH resource linked to the first CCE index n_{CCE} of the corresponding PDCCH is only one. Accordingly, a new method by which the plurality of UEs in the UE group are capable of transmitting ACK/NACK is needed. The following schemes may be considered as the method for transmitting ACK/NACK for plurality of UEs in a UE group in which DL transmission is scheduled by one PDCCH.

A BS may pre-reserve an ACK/NACK PUCCH resource per UE through radio resource control (RRC) signaling etc. That is, a plurality of PUCCH resources for a UE group may be explicitly reserved.

ii) Implicit PUCCH resources may be used by a time division multiplexing (TDM) scheme for ACK/NACK transmission of each of the plurality of UEs in the UE group.

iii) A plurality of implicit PUCCHs linked to CCEs (e.g. n_{CCE}, n_{CCE+1}, . . . ) of a DL grant PDCCH may be dynamically allocated to the UEs.

However, in the case of i), there is a disadvantage of a heavy signaling overhead burden generated for adaptation to a time-varying system situation (e.g. PUCCH region reconfiguration or channel state variation). In the case of ii), a CCE to which a corresponding implicit PUCCH is linked cannot be used to transmit a PDCCH for a prescribed duration and, as a result, restrictions on BS scheduling may occur. In the case of iii), since a plurality of CCEs to which the plurality of implicit PUCCH resources are linked cannot be used to transmit a PDCCH in a corresponding subframe, there are restrictions while the BS performs scheduling for the subframe.

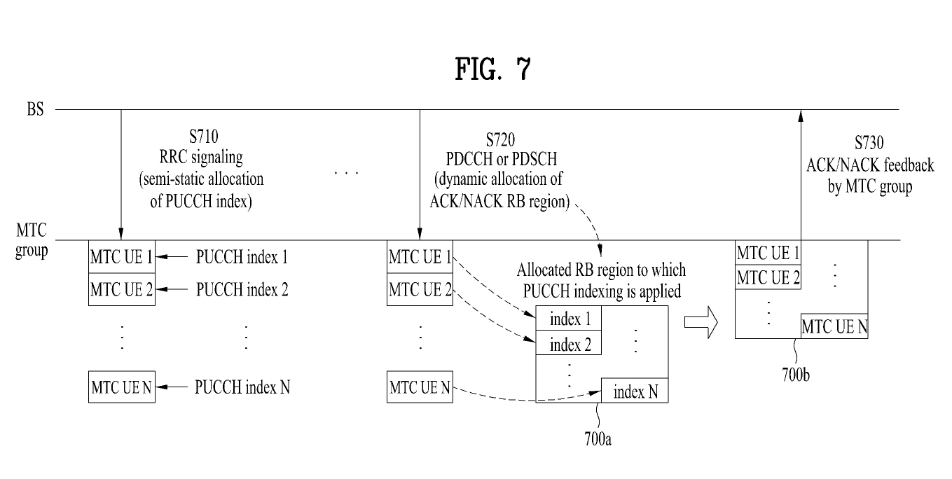

Therefore, the present invention proposes a UE group based ACK/NACK resource allocation and ACK/NACK signal transmission method capable of properly adapting to a time-varying system situation while reducing DL signaling overhead burden and BS scheduling restrictions. Hereinafter, while embodiments of the present invention will be described as an example of MTC, the embodiments of the present invention can be applied irrespective of what MTC is called if a plurality of UEs shares prescribed characteristics and UL/DL data transmission for the plurality of UEs is scheduled by DL control information carried by one DL control channel. Hereinafter, a UE used for MTC will be referred to as an MTC device or MTC UE and a set of MTC UEs scheduled by DCI carried by one PDCCH will be referred to as an MTC group. Detailed embodiments of the present invention are described with reference to FIG. 7.

FIG. 7 illustrates UL ACK/NACK transmission according to the present invention. For reference, “PUCCH index” and “index” denoted in FIG. 7 are simplified expressions of a PUCCH resource index.

According to the present invention, a BS may semi-statically pre-designate/pre-configure ACK/NACK PUCCH resource ID information to be used by each of MTC UEs in an MTC group through higher-layer signaling such as RRC signaling (S710). The BS of the present invention may transmit a (higher layer) signal containing a plurality of ACK/NACK PUCCH resource ID information for the plurality of MTC UEs in the MTC group, configured by a higher layer such as an RRC layer, to the MTC group. Alternatively, the BS of the present invention may transmit a (higher-layer) signal including PUCCH resource ID information for a specific MTC UE in the MTC group, configured by a higher layer such as an RRC layer, to the specific MTC UE. The PUCCH resource ID information may be information indicating a PUCCH resource index/order or information indicating a combination of an RB index, an OCC, and a CS. In the present invention, the PUCCH resource ID information is used to identify an ACK/NACK PUCCH resource to be used by a corresponding MTC UE in the MTC group among ACK/NACK PUCCH resources to be used by one MTC group. FIG. 7 illustrates allocation of a PUCCH resource index (where i=1, 2, . . . , N) to an MTC UE i (where i=1, 2, . . . , N).

The PUCCH resource ID information allocated to an MTC UE in the present invention is different from a legacy PUCCH resource index linked to a CCE index of a PDCCH in that the information identifies one PUCCH resource among partial PUCCH resources rather than one PUCCH resource among all PUCCH resources. In other words, legacy PUCCH resource indexes are absolute indexes or physical indexes statically or semi-statically linked to PUCCH resources used in a corresponding cell, whereas the PUCCH resource ID information of the present invention may be logical indexes semi-statically allocated to MTC UEs in the MTC group rather than indexes statically or semi-statically linked to specific PUCCH resources. Since the PUCCH resource ID information allocated per UE in the MTC group according to the present invention identifies one PUCCH resource among some PUCCH resources, the size thereof is smaller than the size of the legacy PUCCH resource index. That is, if a PUCCH resource index is used as the PUCCH resource ID information per MTC UE of the present invention, the PUCCH resource index per MTC UE of the present invention is shorter than the legacy PUCCH resource index and the legacy PUCCH resource index is longer than the PUCCH resource index per MTC UE of the present invention. Accordingly, according to the present invention, signaling overhead can be reduced compared with the above case i) in which PUCCH resources for the MTC group are semi-statically pre-reserved using the legacy PUCCH resource indexes.

Meanwhile, in the present invention, actual ACK/NACK PUCCH resources to be used by each UE in the MTC group are dynamically allocated (S720). Hereinafter, a set of ACK/NACK PUCCH resources for the MTC group will be referred to as an ACK/NACK resource region for the MTC group. The BS of the present invention may configure the ACK/NACK resource region for ACK/NACK transmission of the MTC group and may dynamically transmit information about the ACK/NACK resource region (hereinafter, ACK/NACK resource information or PUCCH resource information) to the MTC group. The ACK/NACK resource region may be configured by one or more RBs used for ACK/NACK transmission and, in this case, information indicating the one or more RBs used for transmission of an ACK/NACK signal (hereinafter, ACK/NACK RBs) may be transmitted to the MTC group from the BS. The BS may transmit an index of the first PUCCH resource among PUCCH resources for the MTC group to the MTC group as the ACK/NACK resource information. The index indicating the first PUCCH resource is a type of physical index allocated to one PUCCH resource among a plurality of PUCCH resources used in a corresponding cell and is different from a logical index allocated to each UE of the MTC group by the afore-mentioned ACK/NACK resource ID information.

In the present invention, the ACK/NACK resource ID information for the MTC group may be regarded as semi-static information because corresponding configuration is maintained during a time duration corresponding to a plurality of subframes and the ACK/NACK resource information indicating ACK/NACK PUCCH resources for the MTC group may be regarded as dynamic information because the ACK/NACK resource information is valid only during a time duration corresponding to a relatively small number of subframes (e.g. one subframe) by a PDCCH or PDSCH.

The ACK/NACK resource information may be transmitted from the BS to the UE using, for example, one of the following methods. In other words, an ACK/NACK resource region may be allocated to one MTC group according to one of the following methods.

Method 1: ACK/NACK Resource Region Allocation Through DL Grant PDCCH

ACK/NACK resource information for an MTC group may be transmitted from the BS to the MTC group through a DL grant PDCCH. According to Method 1 of the present invention, the BS may inform the MTC group of an ACK/NACK RB region or the first ACK/NACK PUCCH resource, for transmission of ACK/NACK for a PDSCH of the MTC group scheduled by the DL grant PDCCH, through the DL grant PDCCH.

If an ACK/NACK resource region for the MTC group is allocated through the PDCCH, an ACK/NACK PUCCH resource linked to a CCE of the PDCCH (hereinafter, an implicit PUCCH resource) is present. To prevent the ACK/NACK PUCCH resource linked to the CCE of the PDCCH from going to waste, one or more UEs belonging to the MTC group may be configured to use the implicit PUCCH resource as an exceptional case. The UE using the implicit PUCCH resource may be explicitly indicated by the BS or may be pre-defined such that a specific UE (e.g. the first or last MTC UE in a corresponding MTC group) uses the implicit PUCCH resource.

Method 2: ACK/NACK Resource Region Allocation Through PDSCH

The ACK/NACK resource information, which is information about the ACK/NACK resource region for the MTC group, may be transmitted from the BS to the MTC group through a PDSCH of the MTC group scheduled by a DL grant PDCCH. The BS according to Method 2 of the present invention may inform the MTC group of the ACK/NACK RB region or the first ACK/NACK PUCCH resource, for transmission of ACK/NACK for the PDSCH, through payload in the PDSCH of the MTC group scheduled by the DL grant PDCCH.

In this case, the ACK/NACK resource information may be transmitted from the BS to the UE through the PDSCH after joint coding with a DL data part or separate coding from the DL data part. If the ACK/NACK resource information is joint-coded with the DL data part, the ACK/NACK resource information can be detected only when it is determined that the UE has successfully received a DL signal through the PDSCH, that is, when the DL signal is determined as ACK. Therefore, in this case, the MTC UE will feed back only ACK (or DTX) to the BS. If the ACK/NACK resource information is joint-coded with the DL data part, the BS may change an ACK/NACK resource region without performing HARQ combining during retransmission of the DL data or perform HARQ combining without changing the ACK/NACK resource region.

Method 3: ACK/NACK Resource Region Allocation Through ACK/NACK Grant PDCCH

An additional PDCCH may be defined to carry ACK/NACK resource information indicating an ACK/NACK resource region which is a set of ACK/NACK PUCCH resources. That is, in addition to a DL grant PDCCH used for transmission of DL control information for DL data, a PDCCH for transmission of the ACK/NACK resource information may be separately defined. Hereinafter, a PDCCH additionally defined to carry the ACK/NACK resource information indicating the ACK/NACK resource region which is a set of ACK/NACK PUCCH resources will be referred to as an ACK/NACK grant PDCCH. For the ACK/NACK grant PDCCH, an ACK/NACK-dedicated DCI format additionally configured for assignment of an ACK/NACK resource to an MTC group may be used or a general DCI format for a UL grant may be reused (through modification). The ACK/NACK grant PDCCH and a general PDCCH for UL scheduling (i.e. a UL grant PDCCH) may be distinguished by different MTC group IDs (e.g. radio network temporary identities (RNTIs)), by DCI formats having different payload sizes, or by an additional indication flag (or a combination of specific field values) indicating whether DCI transmitted through a corresponding PDCCH is for a UL grant or for ACK/NACK resource region allocation.

The BS according to Method 3 of the present invention may inform the MTC group of the ACK/NACK RB region or the first ACK/NACK PUCCH resource, for transmission of ACK/NACK for a PDSCH of the MTC group, through the ACK/NACK grant PDCCH. DCI carried by the ACK/NACK grant PDCCH may commonly or UE-specifically include a transmit power control (TPC) command for controlling ACK/NACK transmit power, in addition to ACK/NACK resource information.

If an ACK/NACK resource region for the MTC group is allocated through the ACK/NACK grant PDCCH, an ACK/NACK PUCCH resource linked to a CCE of the ACK/NACK grant PDCCH (hereinafter, an implicit PUCCH resource) may be present. To prevent the implicit PUCCH resource from going to waste, one or more UEs belonging to the MTC group may be configured to use the implicit PUCCH resource as an exceptional case. The UEs using the implicit PUCCH resource may be explicitly indicated by the BS or may be pre-defined such that a specific UE (e.g. the first or last MTC UE in a corresponding MTC group) may use the implicit PUCCH resource.

The UE of the present invention may receive a (higher-layer) signal including ACK/NACK PUCCH resource ID information semi-statically allocated/configured for the UE from the BS (S710) and receive ACK/NACK resource information from the BS according to any one of the afore-described methods (S720). The UE may identify an ACK/NACK PUCCH resource therefor among ACK/NACK PUCCH resources included in the ACK/NACK resource region using the ACK/NACK PUCCH resource ID information. If the BS allocates the ACK/NACK resource region to the MTC group by indicating an ACK/NACK RB region, each UE in the MTC group may transmit, to the BS, an ACK/NACK signal for DL data received through a PDSCH thereof, using a PUCCH resource (700b) corresponding to a PUCCH resource index/order (or combination of RB index/OCC/CCS) designated or allocated thereto when PUCCH (or RB/OCC/CCS) indexing is applied (700a) only in the ACK/NACK RB region allocated to the MTC group (S730). If the BS allocates the ACK/NACK resource region to the MTC group using the first ACK/NACK PUCCH resource, each UE in the MTC group may sequentially index PUCCH resources (700a) starting from the first ACK/NACK PUCCH resource and transmit an ACK/NACK signal associated with DL data received through a PDSCH thereof to the BS, using a PUCCH resource (700b) corresponding to a PUCCH resource index/order allocated thereto among the PUCCH resources (S730). For example, referring to FIG. 7 under the assumption that a PUCCH resource index i (where i=1, 2, . . . , N) is semi-statically allocated to an MTC UE i (where i=1, 2, . . . , N), an MTC UE n (where n is an integer satisfying 1≦n≦N) may determine a PUCCH resource corresponding to a PUCCH resource index n allocated to the MTC UE n among PUCCH resources included in the ACK/NACK resource region for a corresponding MTC group as a PUCCH resource for transmission of an ACK/NACK signal of the MTC UE n.

In the above-described Method 3 of the present invention, when an MTC UE that is not scheduled by a PDSCH (or fails to detect a DL grant PDCCH for scheduling a PDSCH) receives ACK/NACK resource information, A) ACK/NACK feedback may be omitted (i.e. DTX) or B) a NACK signal may be transmitted to the BS. In the case of A), the BS cannot discern whether the reason why ACK/NACK feedback is not performed is because the corresponding MTC UE fails to detect the DL grant PDCCH for scheduling the PDSCH or because the MTC UE fails to detect the ACK/NACK grant PDCCH carrying the ACK/NACK resource information. However, in the case of A), even if the BS allocates a PUCCH resource allocated to the corresponding MTC UE to another MTC UE, which is scheduled by the PDSCH and belongs to another MTC group different from an MTC group to which the corresponding MTC UE belongs, according to the ACK/NACK resource information, collision between an ACK/NACK signal of the corresponding MTC UE and an ACK/NACK signal of the other MTC UE can be prevented. Meanwhile, in the case of B), the BS cannot discern whether the reason why NACK is transmitted is because the MTC UE fails to detect the DL grant PDCCH for scheduling the PDSCH or because a reception/decoding result of a signal through the PDSCH is determined as NACK. However, in the case of B), since the BS may recognize that the MTC UE succeeds in detecting the ACK/NACK grant PDCCH carrying the ACK/NACK resource information, the BS may immediately perform PDSCH retransmission without performing an unnecessary process of reallocating the ACK/NACK resource information. In the case of B), since the MTC UE has succeeded in detecting the ACK/NACK grant PDCCH, the MTC UE may transmit ACK/NACK based on the ACK/NACK resource information received through the PDCCH.

In the above-described embodiments of the present invention, the BS may select/designate an MTC UE requiring actual ACK/NACK transmission or prohibiting ACK/NACK transmission among UEs in an MTC group which have received the ACK/NACK resource information and transmit information indicating the selected or designated MTC UE(s) to the MTC group through the DL grant PDCCH, the PDSCH, or the ACK/NACK grant PDCCH. The information indicating the selected or designated MTC UE(s) may be configured in the form of a bitmap etc. In this case, an index of each MTC UE or a bit position in a bitmap corresponding to each MTC UE may be configured through RRC signaling or may be sequentially determined by a PUCCH resource index/order or a combination of an RB index/OCC/CCS designated per MTC UE according to the present invention without additional signaling.

In the above-described embodiments of the present invention, an MTC group in which DL data for plurality of MTC UEs is scheduled (hereinafter, a DL-MTC group) through one PDCCH and an MTC group to which ACK/NACK resource information for plurality of MTC UEs is allocated (hereinafter, A/N-MTC group) through one PDCCH may be identically or independently configured. The BS may configure MTC group(s) such that one A/N-MTC group includes a plurality of DL-MTC groups, conversely, one DL-MTC group includes a plurality of A/N-MTC groups, or one DL-MTC group corresponds to one A/N-MTC group one to one. Meanwhile, in order to increase the degree of freedom of signal transmission through a PDSCH and/or ACK/NACK feedback, the BS may configure MTC group(s) such that one MTC UE belongs to one or more DL-MTC groups and/or one or more A/N-MTC groups.

In addition, a DL-MTC group scheduled by DL data for a plurality of MTC UEs through one PDCCH and an MTC group receiving UL data transmission resource information for plurality of MTC UEs (hereinafter, a UL-MTC group) through one PDCCH may be identically or independently configured. The BS may configure MTC group(s) such that one UL-MTC group includes a plurality of DL-MTC groups, conversely, one DL-MTC group includes a plurality of UL-MTC groups, or one DL-MTC group corresponds to one UL-MTC group one to one. Meanwhile, in order to increase the degree of freedom of signal transmission through a PDSCH and/or signal transmission through a PUSCH, the BS may configure MTC group(s) such that one MTC UE belongs to one or more DL-MTC groups and/or one or more UL-MTC groups.

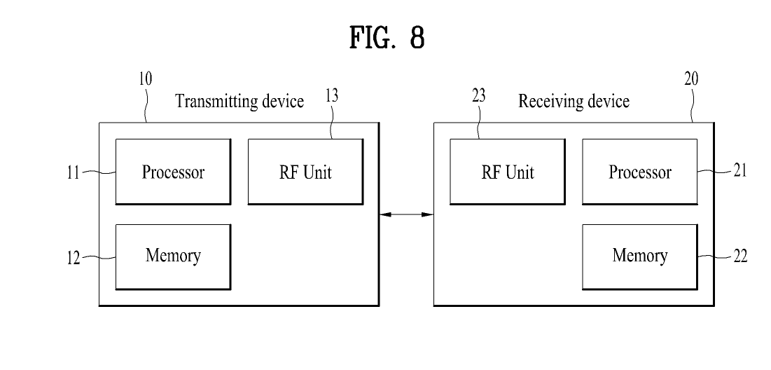

FIG. 8 is a block diagram illustrating elements of a transmitting device 10 and a receiving device 20 for implementing the present invention.

The transmitting device 10 and the receiving device 20 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the RF units 13 and 23 and the memories 12 and 22 to control the elements and configured to control the memories 12 and 22 and/or the RF units 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 performs predetermined coding and modulation for a signal and/or data scheduled to be transmitted to the outside by the processor 11 or a scheduler connected with the processor 11, and then transfers the coded and modulated data to the RF unit 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nₜ (where Nₜ is a positive integer greater than one) transmit antennas.

A signal processing process of the receiving device 20 is the reverse of the signal processing process of the transmitting device 10. Under control of the processor 21, the RF unit 23 of the receiving device 20 receives radio signals transmitted by the transmitting device 10. The RF unit 23 may include Nᵣ receive antennas and frequency down-converts each signal received through receive antennas into a baseband signal. The processor 21 decodes and demodulates the radio signals received through the receive antennas and restores data that the transmitting device 10 intended to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. The signal transmitted from each antenna cannot be further deconstructed by the receiving device 20. An RS transmitted in correspondence to a corresponding antenna defines an antenna viewed from the receiving device 20 and enables the receiving device 20 to perform channel estimation for the antenna, irrespective of whether it is a single radio channel from one physical antenna or a composite channel from a plurality of physical antenna elements including the antenna. In other words, the antenna is defined such that a channel carrying a symbol of the antenna may be obtained from a channel carrying another symbol of the same antenna. An RF unit supporting a MIMO function of transmitting and receiving data using a plurality of antennas may be connected to two or more antennas.

In the embodiments of the present invention, a UE operates as the transmitting device 10 in UL and as the receiving device 20 in DL. In the embodiments of the present invention, a BS operates as the receiving device 20 in UL and as the transmitting device 10 in DL. Hereinafter, the processor, RF unit, and memory included in the UE will be referred to as a UE processor, a UE RF unit, and a UE memory, respectively, and the processor, RF unit, and memory unit included in the BS will be referred to as a BS processor, a BS RF unit, and a BS memory, respectively.

According to the embodiments of the present invention, the BS processor controls the BS RF unit to transmit a PDCCH, a PDSCH, and a PHICH and the UE processor controls the UE RF unit to receive the PDCCH, the PDSCH, and the PHICH. According to the embodiments of the present invention, the UE processor controls the UE RF unit to transmit a PUCCH and a PUSCH and the BS processor controls the BS RF unit to receive the PUCCH and the PUSCH.

The BS processor of the present invention may semi-statically designate/configure ACK/NACK PUCCH resource ID information to be used by each of plurality of MTC UEs in an MTC group. The PUCCH resource ID information may be configured by a higher layer of the BS processor. Referring to FIG. 7, the BS processor may control the BS RF unit to transmit the PUCCH resource ID information to one or more UEs belonging to the MTC group (S710). The BS processor of the present invention may control the BS RF unit to transmit a (higher-layer) signal including a plurality of ACK/NACK PUCCH resource ID information for each of the plurality of MTC UEs in the MTC group to the plurality of MTC UEs in the MTC group. Alternatively, the BS processor of the present invention may control the RF unit to transmit a (higher-layer) signal including the PUCCH resource ID information for a specific MTC UE in the MTC group to the specific MTC UE.

Meanwhile, the BS processor of the present invention may dynamically configure/allocate an ACK/NACK resource region, which is a set of ACK/NACK PUCCH resources for the MTC group (S720). The BS processor may control the BS RF unit to transmit ACK/NACK resource information indicating the configured/allocated ACK/NACK resource region to UE(s) belonging to the MTC group. The BS processor may control the BS RF unit to transmit the ACK/NACK resource information through a DL grant PDCCH, a PDSCH scheduled by the DL grant PDCCH, or an ACK/NACK grant PDCCH defined separately for transmission of the ACK/NACK resource information.

The UE RF unit of the present invention may receive the (higher-layer) signal including the ACK/NACK PUCCH resource ID information semi-statically allocated/designated to the UE under control the UE processor (S710) and receive the ACK/NACK resource information from the BS through the PDCCH or PDSCH according to any one of the above-described methods (S720). The UE processor may control the UE RF unit to transmit ACK/NACK information for DL data received from the BS based on the PDCCH resource ID information and the ACK/NACK resource information. The UE processor may control the UE RF unit to transmit the ACK/NACK information using a PUCCH resource corresponding to PUCCH resource ID information allocated to the UE among ACK/NACK PUCCH resources indicated by the ACK/NACK resource information. If the ACK/NACK resource information is information indicating an ACK/NACK resource RB region, the UE processor may apply PUCCH (or RB/OCC/CCS) indexing only to the ACK/NACK RB region allocated to an MTC group to which the UE belongs (700a). The UE processor may control the UE RF unit to transmit an ACK/NACK signal for DL data received through a PDSCH scheduled to the UE to the BS using a PUCCH resource (700b) corresponding to a PUCCH resource index/order (or a combination of an RB index/OCC/CCS) designated or allocated to the UE. If the ACK/NACK information is information indicating the first ACK/NACK PUCCH resource, the UE processor may sequentially index PUCCH resources starting from the first ACK/NACK PUCCH resource allocated to an MTC group to which the UE belongs. The UE processor may control the UE RF unit to transmit an ACK/NACK signal associated with DL data of the UE received through the PDSCH to the BS using a PUCCH resource (700b) corresponding to a PUCCH resource index/order allocated to the UE among the PUCCH resources (S730).

If the embodiments proposed in the present invention are applied to communication between a plurality of UEs and a BS, more efficient ACK/NACK feedback transmission can be performed. As described above, the present invention may be applied not only to low-speed communication between a plurality of MTC UEs and a BS but also to various types/purposes of communication between a plurality of normal UEs and a BS.

The detailed description of the exemplary embodiments of the present invention has been given hereinabove to enable those skilled in the art to implement and practice the invention. Although the invention has been described with reference to the exemplary embodiments, those skilled in the art will appreciate that various modifications and variations can be made in the present invention without departing from the spirit and scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The embodiments of the present invention are applicable to a BS, a relay, a UE, or other devices in a wireless communication system.

1. A method for transmitting an uplink signal to a base station by a user equipment included in a user equipment group including a plurality of user equipments in a wireless communication system, the method comprising:
receiving a higher-layer signal including physical uplink control channel (PUCCH) resource ID information allocated to the user equipment from the base station;
receiving acknowledgement (ACK)/negative ACK (NACK) resource information indicating a set of PUCCH resources available for ACK/NACK transmission of the user equipment group from the base station through a physical downlink control channel (PDCCH) or a physical downlink shared channel (PDSCH); and
transmitting an ACK/NACK signal for downlink data received from the base station to the base station using a PUCCH resource corresponding to the PUCCH resource ID information allocated to the user equipment among the set of the PUCCH resources.

2. The method according to claim 1, wherein the PUCCH resource ID information allocated to the user equipment is information for identifying one PUCCH resource in the set of the PUCCH resources.

3. The method according to claim 1, wherein the ACK/NACK resource information is information indicating a first PUCCH resource in the set of the PUCCH resources or information indicating one or more resource blocks occupied by the set of the PUCCH resources.

4. The method according to claim 1, wherein the PDCCH through which the ACK/NACK resource information is received is different from a PDCCH through which downlink control information for the downlink data is transmitted.

5. A user equipment included in a user equipment group including a plurality of user equipments, for transmitting an uplink signal to a base station in a wireless communication system, the user equipment comprising:
a radio frequency (RF) unit configured to transmit/receive a signal; and
a processor configured to control the RF unit,
wherein the processor controls the RF unit to receive a higher-layer signal including physical uplink control channel (PUCCH) resource ID information allocated to the user equipment from the base station, controls the RF unit to receive acknowledgement (ACK)/negative ACK (NACK) resource information indicating a set of PUCCH resources available for ACK/NACK transmission of the user equipment group from the base station through a physical downlink control channel (PDCCH) or a physical downlink shared channel (PDSCH), and controls the RF unit to transmit an ACK/NACK signal for downlink data received from the base station to the base station using a PUCCH resource corresponding to the PUCCH resource ID information allocated to the user equipment among the set of the PUCCH resources.

6. The user equipment according to claim 5, wherein the PUCCH resource ID information allocated to the user equipment is information for identifying one PUCCH resource in the set of the PUCCH resources.

7. The user equipment according to claim 5, wherein the ACK/NACK resource information is information indicating a first PUCCH resource in the set of the PUCCH resources or information indicating one or more resource blocks occupied by the set of the PUCCH resources.

8. The user equipment according to claim 5, wherein the PDCCH through which the ACK/NACK resource information is received is different from a PDCCH through which downlink control information for the downlink data is transmitted.

9. A method for receiving, by a base station, an uplink signal from a user equipment included in a user equipment group including a plurality of user equipments in a wireless communication system, the method comprising:
transmitting a higher-layer signal including physical uplink control channel (PUCCH) resource ID information allocated to the user equipment to the user equipment;
transmitting acknowledgement (ACK)/negative ACK (NACK) resource information indicating a set of PUCCH resources available for ACK/NACK transmission of the user equipment group to the user equipment through a physical downlink control channel (PDCCH) or a physical downlink shared channel (PDSCH); and
receiving an ACK/NACK signal for downlink data transmitted to the user equipment from the user equipment using a PUCCH resource corresponding to the PUCCH resource ID information allocated to the user equipment among the set of the PUCCH resources.

10. A base station for receiving an uplink signal from a user equipment included in a user equipment group including a plurality of user equipments in a wireless communication system, the base station comprising:
a radio frequency (RF) unit configured to transmit/receive a signal; and
a processor configured to control the RF unit,
wherein the processor controls the RF unit to transmit a higher-layer signal including physical uplink control channel (PUCCH) resource ID information allocated to the user equipment to the user equipment, controls the RF unit to transmit acknowledgement (ACK)/negative ACK (NACK) resource information indicating a set of PUCCH resources available for ACK/NACK transmission of the user equipment group to the user equipment through a physical downlink control channel (PDCCH) or a physical downlink shared channel (PDSCH), and controls the RF unit to receive an ACK/NACK signal for downlink data transmitted to the user equipment from the user equipment using a PUCCH resource corresponding to the PUCCH resource ID information allocated to the user equipment among the set of the PUCCH resources.
